(19) United States
(12) Patent Application Publication
(10) Pub. No.: US 2014/0143870 A1
(43) Pub. Date: May 22, 2014

(54) METHOD AND SYSTEM FOR REDUCING CYBER ATTACKS

(71) Applicants: Stuart O. Goldman, Scottsdale, AZ (US); Karl F. Rauscher, Emmaus, PA (US); Peter Gillis Castenfelt, London (GB)

(72) Inventors: Stuart O. Goldman, Scottsdale, AZ (US); Karl F. Rauscher, Emmaus, PA (US); Peter Gillis Castenfelt, London (GB)

(21) Appl. No.: 13/683,707

(22) Filed: Nov. 21, 2012

(51) Int. Cl. H04L 29/06

(52) U.S. Cl. CPC H04L 63/1441
USPC 726/23

(57) ABSTRACT

A system and method for reducing cyber attacks on vetted web sites includes a haven web site hosted on a server computer. A list of certified web sites meeting specified criteria is maintained by the haven web site. The certified list is accessible over a global computer network for query or download. A computer virus or the like, operating on a remote computer, runs software coding, available for download on the haven web site, that determines whether a proposed targeted address is on the certified list. If so, the attack by the remote computer is aborted, and if not, the attack proceeds. Alternatively, a certification marker is included on certified web sites, and the remote computer runs software coding, available for download on the haven web site, to determine whether a proposed targeted address corresponds to a certified web site.

### BACKGROUND OF THE INVENTION

1. Field of the Invention

The present invention relates generally to so-called “cyber attacks” upon global computer network web sites, and more particularly, to a method and system for reducing the likelihood of such cyber attacks upon qualifying web sites.

2. Description of the Relevant Art

Inherent in the expansion of cyberspace (the Internet or World Wide Web) are resultant new and progressively greater vulnerabilities for all user entities. Yet, in cyberspace the law of the jungle prevails. Criminal acts, such as hacking, as well as worms and viruses, proliferate indiscriminately throughout the world. New cyber weapons are being developed as nation states establish so called cyber commands. As a result of such belligerent acts, sudden catastrophic failures can occur, not only to particular entities, but also on system levels, and constitute clear and present threats. The issue is well recognized and has been a focal point of discussion at countless cyber forums. Anti-virus software and internet security software has been made available in an effort to overcome such problems. However, such software must be constantly developed, and then redeveloped, as technically-skilled crooks, spammers, and trouble-makers find flaws in it.

Clearly, most people who use the Internet are not attackers. A smaller number of people who use the Internet have no moral ethics at all, do not care about any damage that they cause, and will indiscriminately attack all entities without regard to the nature or purpose of the entity. However, it is believed that some people engaged in cyber attacks of one form or another still have some reservations about attacking a web site that is engaged primarily in humanitarian, rather than, purely commercial, purposes. If a particular web site is regarded as primarily serving the public, rather than serving its owners, then such cyber attackers may be less likely to target such web sites. This is the class of cyber attackers to whom the present invention is directed.

A physical world analogy may be helpful in explaining the basis of the present invention. Most people do not set fires, and will not burn any building. A few people, e.g., a pyromaniac, will burn buildings when given any opportunity to do so. However, some people who are inclined to light buildings on fire will nonetheless pass over buildings such as churches, hospitals, and the like because they are perceived to be a “safe harbor” for the public, and engaged primarily in humanitarian efforts that benefit the general good.

On the other hand, authors of worms, viruses, and other malware can be lazy, and given the ever-increasing number of web sites, the attacker would have to research each potential entity to decide whether or not it should be attacked. Authors of such malware are not willing to spend the time either to research whether a particular web site is worthy of being avoided, or to modify the software code of the worm or virus to avoid worthy web sites. As a result, such web sites can often be attacked even when the author of such worm or virus might have preferred to avoid such web sites. From the viewpoint of such authors, it is simply not worth the time that would need to be invested to avoid such web sites.

It is unrealistic in today's Internet environment to expect an attacker (manually or via a software application) to identify entities that should not be attacked unless they can be easily identified. However, if one could make it simple for such authors of worms, viruses and malware to readily distinguish between web sites associated with humanitarian organizations as compared to primarily commercial web sites, then at least some of such authors would be likely to avoid cyber attacks upon web sites associated with humanitarian organizations.

Within an international patent application published as International Publication No. WO 2012/083314 A2, on Jun. 21, 2012, two of the inventors named in the present application described one possible solution, namely, using a domain name for protected web sites that includes a component which alerts potential cyber attackers to the character of the intended target. This disclosure describes a rigorous “vetting” process for confirming that participating web sites qualify for a particular top level domain name, or super TLD. This disclosure further notes that public knowledge of such rigorous vetting process is directly correlated with the success of such a concept. The concept was to vet subscribers and then add them to the TLD space with the hope that the bad guys would pass over such designated sites. Returning to the hospital analogy, the concept was similar to painting a red cross on the hospital building.

The aforementioned international application discloses the use of top level domain names (TLDs), or a so-called super TLD, to signal that a web site is worthy of protection. A TLD is a domain at the highest level in the Internet's hierarchical Domain Name System, which effectively translates host names (easy for people to read) to IP (internet protocol) addresses (easy for computers to read). Currently, a TLD is the last part of the domain name string, that is, the last label of a fully qualified domain name, for example, in the domain name www.test.com, the top-level domain is com.

However, the above-mentioned concept of using TLDs to identify web sites worthy of protection is not without its difficulties. There are a large number of TLDs already in use, including at least 22 top level generic domain names, as well as a host of country names. ICANN (The Internet Corporation for Assigned Names and Numbers), who is charged with managing TLDs, will soon be opening up top level domains, so there could soon be thousands of different TLDs.

Some top level domains may give an appearance of a grouping of entities that should not be attacked (e.g., “.org”), but many of such entities may not be vetted (so anyone can obtain a URL within that top level domain). Vetting is important; even though a particular organization may be a hospital, or a church, protection might not be merited. Examples include a hospital that does research to promote chemical warfare agents, or a church dedicated to Satan. Other top level domains, such as .gov, contain both military as well as humanitarian entities, so the humanitarian entities would not be identified easily for protection under any particular ethical criteria.

There are other practical issues raised by using TLDs to identify qualified entities. Because TLDs are controlled and assigned only by ICANN, the TLD approach would likely have a high start-up cost, and changes and updates would be difficult to effect in real time. A very significant drawback is that entities would need to change their URL to join. Many entities would want to be in a TLD descriptive of their service and thus would choose not to participate. Attack engines stepping through IP addresses, rather than URLs, would need to perform a “whois” lookup on each IP address, and determine whether the resulting TLD is protected. Once again, the TLD assignment process is controlled by ICANN and authorized registries, and there are expenses imposed for adding new domains. In addition, the above-described TLD scheme does not work for non-ASCII URLs. Referring again to the hospital analogy, painting a red cross on a hospital building does not help protect from high-level night time bombing if the planes flying overhead cannot see it.

Accordingly, it is an object of the present invention to provide a method and system for reducing the likelihood of cyber attacks upon deserving web sites that can be implemented relatively quickly.

Another object of the present invention is to provide such a method and system that can be implemented independently of ICANN and its authorized registries.

Still another object of the present invention is to provide such a method and system that can be implemented and maintained with relatively low cost.

A further object of the present invention is to provide such a method and system that allows an entity to keep its existing URL and top level domain.

A still further object of the present invention is to provide such a method and system compatible with URLs/domain names that include virtually all languages and character sets.

Yet another object of the present invention is to provide such a method and system wherein participating attack engines (such as infected “bot” computers) can determine whether a web site should be avoided without the need to first access, or slow down, the potentially targeted site.

These and other objects of the invention will become more apparent to those skilled in the art as the description of the present invention proceeds.

### SUMMARY OF THE INVENTION

Briefly described, and in accordance with a preferred embodiment thereof, the present invention relates to a method for protecting global network web sites from cyber attacks, wherein certifying a number of global network web sites are reviewed, or “vetted”, to determine whether they are deserving of protection, e.g., that the operator of such web site meets or exceeds certain pre-defined criteria. For example, certification may include confirmation that the operator of a particular web site engages in primarily humanitarian activities. If the web site under study meets such criteria, such web site is “certified”. A list of such certified web sites is compiled; such list may include URLs (Uniform Resource Locators, in the form of a formatted text string), IP addresses (four sets of numbers from 0 to 255, separated by three dots, e.g., “216.239.115.148”), or both. A global network haven web site is hosted on a computer server; the haven web site has access to the list of certified web sites.

One or more remote computers (e.g., infected “bot” computers) are provided from which to conduct a cyber attack upon a targeted web site hosted at a target address. Before initiating an attack, the remote computer transmits a proposed target address to the haven web site to determine whether the proposed target address corresponds to a certified web site. In response, a signal is sent from the haven web site to the remote computer indicating whether the web site corresponding to the proposed target address is on the list of certified web sites. The remote computer is then operated to either proceed with a cyber attack upon the proposed target address (if the target address is not on the certified list), or to refrain from a cyber attack upon the proposed target address (if the target address is included on the certified list).

Preferably, the haven web site includes an electronic file containing computer software that may be operated by a remote computer to facilitate communication with the haven web site, so that the remote computer can determine whether or not a web site corresponding to a propose target address is included in the list of certified web sites. This computer software can be freely downloaded from the haven web site by one planning to conduct cyber attacks; the cyber attacker can them simply add such software to the computer virus that the cyber attacker is distributing.

In regard to another embodiment, a remote computer being directed to engage in an attack first establishes a link between itself and the haven web site over a global computer network, and then downloads the current list of certified web sites from the computer server that hosts the haven web site. The remote computer is thereafter operated to determine whether the proposed target address corresponds to a certified web site included in the downloaded list of certified web sites. The remote computer is further operated to either proceed with, or refrain from, a cyber attack upon the proposed target address, depending upon whether or not the web site corresponding to the proposed target address is included in the downloaded list of certified web sites.

In yet another embodiment of the present invention, a request is received from an operator of a web site to be certified as a web site deserving of protection. The certifying authority evaluates such request to determine whether the web site complies with certain criteria. If so, the certifying authority grants certification for such web site, and authorizes the operator of a certified web site to add a certification marker to the certified web site to indicate that the web site is a certified web site deserving of protection.

One or more remote computers (e.g., infected “bot” computers) are provided, each being capable of conducting a cyber attack upon a targeted web site hosted at a target address. A link is established, in this case, directly between the remote computer and the targeted web site over a global computer network. The remote computer determines whether the targeted web site includes the certification marker. If the remote computer determines that the certification marker is present on the targeted web site, then the remote computer is operated to refrain from attacking such web site. On the other hand, if the remote computer determines that the certification marker is lacking on the targeted web site, then the remote computer is operated to proceed with the attack on such web site.

As before, the haven web site may include an electronic file containing computer software that may be operated by the remote computer to facilitate communication with targeted web sites over the global computer network to search for the certification marker on such web site. Preferably, such computer software can be freely downloaded from the haven web site by one planning to conduct cyber attacks for being included in a computer virus prior to distribution.

Apart from the above-described methods, an alternate embodiment of the present invention is a system for protecting global network web sites from cyber attacks, and includes a computer server coupled to a global computer network and hosting a haven web site; the haven web site includes a list of certified web sites deserving of protection against cyber attacks. The system also includes one or more remote computers coupled to the global computer network, each being capable of conducting a cyber attack upon a targeted web site hosted at a target address. Each remote computer derives a proposed target address against which to mount a cyber attack, and transmits the proposed target address to the haven web site to determine whether the proposed target address corresponds to a certified web site. The haven web site responds by signaling whether the web site that corresponds to the proposed target address is included in the list of certified web sites. The remote computer then proceeds with, or refrains from, a cyber attack upon the proposed target address, depending upon whether or not the web site corresponding to the proposed target address is included in the list of certified web sites.

In the aforementioned system, the haven web site preferably includes an electronic file containing computer software that may be operated by the remote computer for the purpose of communicating with the haven web site to determine whether or not a targeted web site is included in the list of certified web sites. Such computer software can be freely downloaded from the haven web site by one planning to conduct cyber attacks for being included in a computer virus prior to distribution thereof.

In yet another embodiment, a system for protecting global network web sites from cyber attacks includes a computer server coupled to a global computer network and hosting a haven web site. A list of certified web sites deserving of protection against cyber attacks is accessible from the haven web site. One or more remote computers are coupled to the global computer network, each being capable of conducting a cyber attack upon a targeted web site hosted at a target address. Each remote computer is adapted to link itself, over the global computer network, to the computer server hosting the haven web site to download a copy of the list of certified web sites. Each remote computer derives a proposed target address against which to mount a cyber attack. Each remote computer compares the proposed target address to the downloaded list of certified web sites to determine whether the proposed target address corresponds to a certified web site in the list. The remote computer then proceeds with, or refrains from, a cyber attack upon the proposed target address, depending upon whether or not the web site corresponding to the proposed target address is included in the downloaded list of certified web sites.

Returning to the analogy of physical buildings like hospitals, the use of the certified list and/or certification marker is similar to publicly publishing in the newspaper the coordinates of all genuine hospitals, churches, orphanages, etc. in the country. The enemy would then have no excuse for bombing them. In effect, the present invention applies the principles of warfare under the Geneva Convention into cyberspace, thereby preserving the principles for special treatment of purely humanitarian entities as provided for under international humanitarian law.

### BRIEF DESCRIPTION OF THE DRAWINGS

FIG. 1 is a schematic diagram representing a computerized network including a server for a haven web site, a server for a protected web site, a remote computer owned by an author of a virus, and two remote computers infected with such virus.

FIG. 2 is a flowchart illustrating a first embodiment of the present invention wherein a remote computer links to a haven web site to determine whether a targeted address should be avoided.

FIG. 3 is a flowchart illustrating a second embodiment of the present invention wherein a remote computer links to a haven web site to download a list of certified web sites to be avoided.

FIG. 4 is a flowchart illustrating a third embodiment of the present invention wherein a remote computer links directly to a targeted web site to determine whether a certification marker is included in such web site before determining whether to attach such web site.

### DETAILED DESCRIPTION OF THE PREFERRED EMBODIMENT

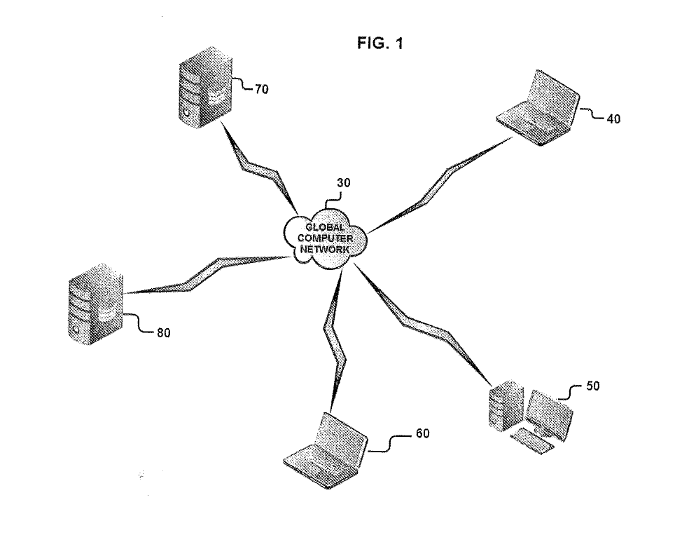

With reference to FIG. 1, a global computer network, e.g., the “Internet”, is indicated by bubble 30. Laptop computer 40 is owned by an author of a cyber attack virus, and is coupled to computer network 30. Remote computers 50 and 60 represent computers owned by third parties, and which are infected with the virus authored by the owner of computer 40, and which are also coupled to computer network 30.

Computer server 70 is connected to computer network 30 and hosts a web site under potential attack by the aforementioned virus carried by remote computers 50 and 60. Computer server 80, on the other hand, hosts a haven web site to be described in greater detail below.

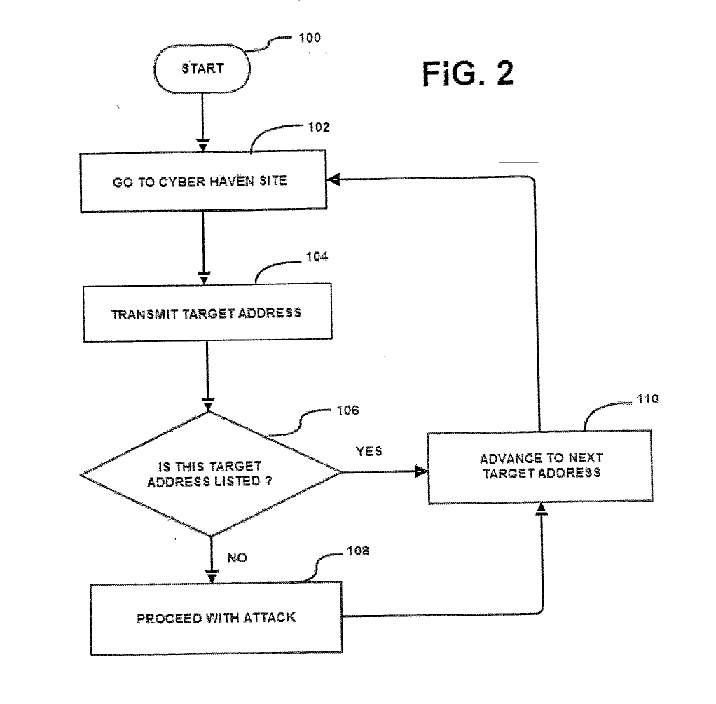

Now, in regard to FIGS. 1 and 2, let us assume that the virus author, owner of laptop 40 in FIG. 1, has a social conscience, and elects to participate in the “Cyber Haven” protection program. In that case, the virus author browses to the haven web site hosted on computer server 80. The virus author may then download from computer server 80, over network 30, a small software code module for incorporation into the virus coding. The virus author includes this small code module in the computer virus before causing it to be distributed to remote computers, like remote computers 50 and 60.

If desired by the virus author, the virus author could also download and capture the list of certified web sites. The virus author could do this from laptop 40, subject to a risk of being traced. On the other hand, the virus author could easily download both the small software code module and the certified web site list, without being traced, by, for example, using a public computer at the public library, or at an Internet caf, and transferring such files to a flash drive. Presumably, the virus author already knows how to protect himself from being traced when he sends out the virus. In addition, it should be remembered that the attacker is often not directly attacking the target, but is instead using an array of captured (infected with control software) home computers (BOTS), like computers 50 and 60, to do so. It is these BOT computers that would normally be instructed to conduct an attack.

The operator of the haven web site performs a rigorous vetting for entities wishing to be identified as certified web sites. For example, the operator of the haven web site might verify that an applicant web site engages in primarily humanitarian activities. More details concerning this vetting process are described within the aforementioned international patent application published as International Publication No. WO 2012/083314 A2, on Jun. 21, 2012, the contents of which are hereby incorporated by reference. Preferably, the operator of the haven web site includes both the URLs and IP addresses of entities that pass the publicly-shared vetting criteria into a corresponding list of certified web sites. If desired, both the haven web site and the current list of certified web sites can be hosted in “the cloud”.

After confirming that applicant web sites seeking certification actually comply with certification criteria, the operator of the haven web site certifies that each such web sites is deserving of protection. The operator of the haven web site compiles such certified web sites deserving of protection into a certified list. The haven web site hosted on computer server 80 (see FIG. 1) has access to such list of certified web sites.

The scheme illustrated in FIG. 2 shows a first embodiment of program flow in the remote computer (50 or 60) as implemented by the software code module downloaded by the virus author from the haven web site. Flow begins at Start step 100 and passes to step 102, at which the remote computer accesses global computer network 30 to connect with the haven web site. At any particular point in time, remote computer (50 or 60) has a specific target address under focus. The targeted address is typically determined by the virus by whatever means. Examples include “walking” through URLs, “walking” through IP addresses (lto n), or using addresses in the contact lists and history files of the infected remote computer. Once connected with the haven web site, the remote computer transmits thereto the current target address, as indicated by step 104, to determine whether the proposed target address corresponds to a certified web site.

The haven web site, after receiving such inquiry, responds by sending a signal back to the remote computer (50 or 60) indicating whether the web site corresponding to the proposed target address is included in the list of certified web sites maintained by the haven web site; this signal might simply be a confirmation that the targeted web site is on the certified list, or an indication that the targeted address was not found on the list.

Control within the remote computer (50 or 60) proceeds to decision step 106. If the target address was on the certified list, control passes directly to step 110 for advancing to the next targeted address. If, on the other hand, the target address was not on the certified list, then control passes to step 108, and the remote computer proceeds with the attack on the web site corresponding to the targeted address. In that case, once the attack is made, control passes to step 110 for advancing to the next targeted address. The remote computer (50 or 60) then repeats the described process by going back to step 102 for checking on the next targeted address.

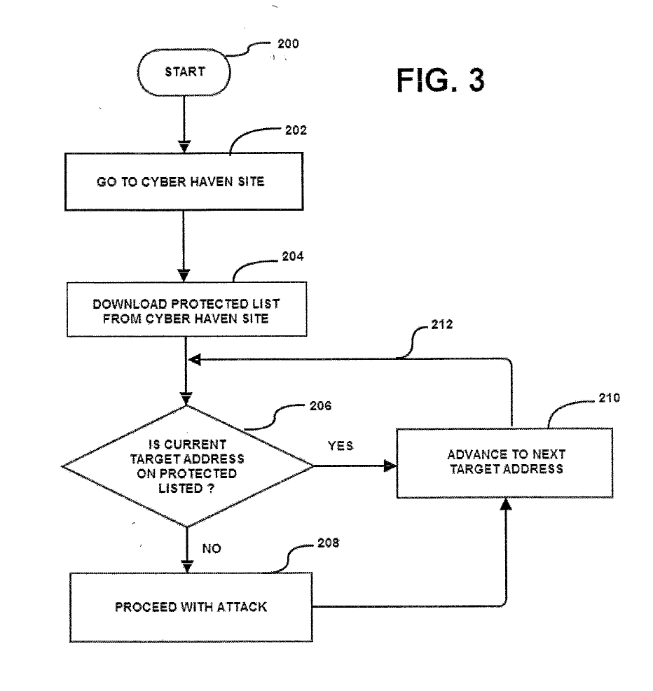

The scheme illustrated in FIG. 3 shows a second embodiment of program flow in the remote computer (50 or 60) as implemented by the software code module downloaded by the virus author from the haven web site. Flow begins at Start step 200 and passes to step 202, at which the remote computer (50 or 60) accesses global computer network 30 to connect with the haven web site. Once connected with the haven web site, the remote computer downloads from the haven web site the current list of certified web sites, as indicated by step 204.

Now, the remote computer (50 or 60) can itself check a currently targeted address against the downloaded certified list to determine whether the web site corresponding to the proposed target address is included in the list of certified web sites maintained by the haven web site, since a copy of the certified list now resides in the memory of the remote computer. Control within the remote computer (50 or 60) proceeds to decision step 206. If the target address was on the certified list, control passes directly to step 210 for advancing to the next targeted address. If, on the other hand, the target address was not on the certified list, then control passes to step 208, and the remote computer proceeds with the attack on the web site corresponding to the targeted address. In that case, once the attack is made, control passes to step 210 for advancing to the next targeted address. The remote computer (50 or 60) then repeats the described process by going back to step 206, via path 212, for checking on the next targeted address.

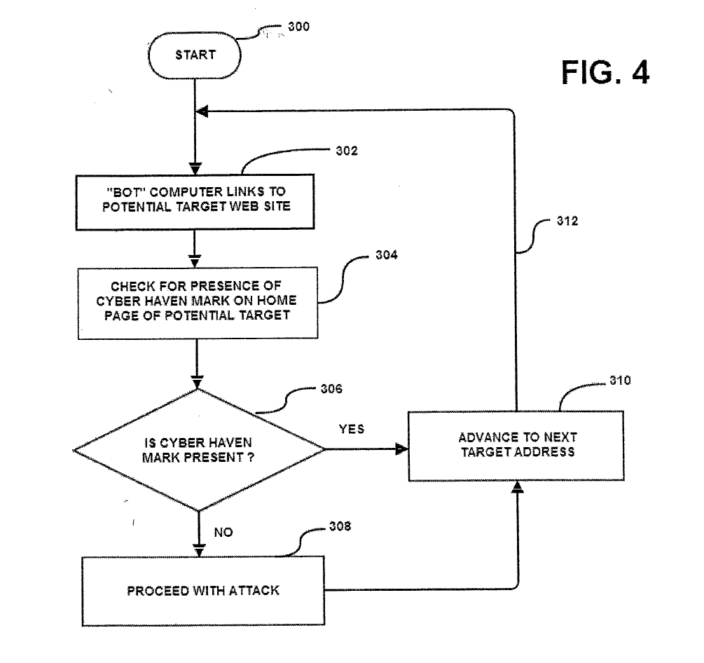

The scheme illustrated in FIG. 4 shows a third embodiment of program flow in the remote computer (50 or 60) as implemented by the software code module downloaded by the virus author from the haven web site. In this scheme, however, it is necessary for remote computers (like 50 or 60) to actually establish a link between the remote computer and the targeted web site (on computer server 70) over computer network 30 before deciding whether or not to proceed with a cyber attack. In this embodiment, as before, the certifying authority (e.g., the operator of the haven web site) evaluates an applicant's request to determine whether the web site complies with published criteria; if so, the certifying authority authorizes the applicant to add a certification marker to the certified web site to indicate that the web site is a certified web site deserving of protection. This certification marker could take many forms, including a digital code, a graphic image, etc.

Returning to FIG. 4, flow begins at Start step 300 and passes to step 302, at which the remote computer accesses global computer network 30 to connect directly with the targeted web site hosted by computer server 70. Once connected with the targeted web site, the remote computer checks for the presence of the certification marker on the home page of the potential target, as indicated by step 304, to determine whether the proposed targeted web site corresponds to a certified web site.

Control within the remote computer (50 or 60) proceeds to decision step 306. If the targeted web site includes the required certification marker, control passes directly to step 310 for advancing to the next targeted address. If, on the other hand, the target address was not on the certified list, then control passes to step 308, and the remote computer proceeds with the attack on the current web site. In that case, once the attack is made, control passes to step 310 for advancing to the next targeted address. The remote computer (50 or 60) then repeats the described process by going back to step 302 via path 312 to visit the next targeted web site.

All of the above-described embodiments of the present invention can potentially reduce the likelihood that infected computers will spread a virus to, or otherwise direct an attack toward, entities that have been vetted, and certified as deserving protection in cyberspace. By being included on the certified list, or by including the certification marker on the entity's web site, the protected entity is able to increase recognition of its humanitarian mission, and indicate to a third party attacker that the entity is a certified, vetted member in good standing, in compliance with the humanitarian criteria published by the certifying authority.

It should be noted that it is not the intention of the present scheme to try to trace the virus creator/author. In most cases, it is the infected computers that are addressing the have web site hosted on server computer 80, and not the creator/author himself. The haven web site will be able to detect the query from the affected “bot” computer (50/60), either the query seeking to determine whether the potential target is on the certified list, or the query seeking to download the current certified list. Nonetheless, it may not be wise for the certifying authority to attempt to have server computer 80 identify each “bot” computer; while such identification could theoretically help remove infections of such virus, such efforts might also discourage virus creators from including the code used to check for certification in the first place.

One of the advantages of the present invention, at least in regard to the embodiments described in conjunction with FIGS. 2 and 3, is that “protected” (certified) web sites may avoid extra traffic. While infected computers may frequently visit the haven web site to check whether a potential target is certified, this merely increases traffic on the haven web site, and not on the “protected” web site. Protected entities are not subjected to any level of distributed denial of service attack, which would be the case if the virus went to the actual protected website to see search for a certification marker. Thus, the haven web site effectively operates as a sacrificial resource that can be optimized for bursts of simple query/response traffic, rather than the more complex conversational traffic experienced in general with the entities being protected. for controlling the execution speed of the virus rather than the protected website. During a “virus storm”, protected web sites would continue to only be accessed by legitimate users, while infected computers would concern themselves with the haven web site and any targeted, uncertified web sites.

The haven web site could be distributed and duplicated. While such haven web sites would, by design, repeatedly be contacted by infected “bot” computers, the haven web sites can be distributed in the “cloud”, and can share the load of such queries. To some extent, the haven web sites can be adjusted to give a somewhat slower response to each query, resulting in a slow-down of the virus itself.

It is also theoretically possible for a virus creator to capture/download the entire certified list from the haven web site before distributing the virus, and actually include the downloaded certified list within the virus itself. While this would avoid the need for the infected computer to itself contact either the haven web site or the targeted web site to check for certification, it would also makes the virus much larger. Moreover, the certified list embedded in the virus itself would quickly be out-of-date by the time the virus is spread, thereby denying protection to more recently-certified web sites.

With respect to the inclusion of a certification marker within the protected web site itself, there may be value in having a marker visible on a web site publicizing that the entity has been vetted and certified as being purely humanitarian, and deserving of protection and respect. This value is maximized by having the marker understandable by a “visitor.” Such a “visitor” could be a human, a search program compiling information about protected sites, or a virus which, upon detecting the certification marker, may choose to abort an attack.

One mechanism that could be used is a specific standardized query construction that would not be understood by an unprotected entity. A protected entity may choose to add specific software that would recognize the query and respond with a standardized message proclaiming protected certified status. Since this mechanism is based on a self declared status by the entity, its value is limited, but may be used as long as the self-declaration is not greatly abused by entities that have not been vetted.

The specific certification marker is a matter of implementation, and could change over time. There could be a “universal” marker that is easily recognized internationally. Alternately or additionally, there could be many local variations of a certification marker based on language, alphabet characters, additional affiliations, etc. Such markers could all be registered certification marks owned by the certifying authority, and the complete list of such markers could be posted on the haven web site. Legal action for unauthorized use of such registered certification marks could be used to control unauthorized infringers. Violators could be put on a list that is publicly shared on the haven web site (i.e., identified by a “mark of Cain”). If desired, a “visitor” to a web site that claims to be certified could verify compliance by querying the haven web site. This could be a direct query, or the visitor could simply click on an extension button in the web browser control line. The browser would then create a query using the current browsed address and send it to the haven web site. Such a query might, for example, cause the extension button in the visitor's web browser to turn green if such web site is indeed certified, or red if the current browsed address is not on the certified list.

Those skilled in the art will now appreciate that a method and system for reducing the likelihood of cyber attacks upon deserving web sites has been described that can be implemented relatively quickly and inexpensively. The disclosed method and system can be implemented independently of ICANN and its authorized registries. The method and system described above are compatible with all existing and future top level domains, and can work with virtually all languages and character sets, so entities can retain their current URLs and top level domains and still benefit. The initial set-up and maintenance fees are easily managed. Further, for the embodiments that direct infected computers to access the haven web site before launching an attack, participating attack engines (such as infected “bot” computers) can determine whether a web site should be avoided without the need to access and/or slow down the potentially targeted site. In addition, while the scheme described above has been described with application to stand-alone web sites, the invention is extendable to social media web sites as well, such as Facebook and Twitter web pages maintained on behalf of humanitarian entities.

While the present invention has been described with respect to preferred embodiments thereof, such description is for illustrative purposes only, and is not to be construed as limiting the scope of the invention. Various modifications and changes may be made to the described embodiments by those skilled in the art without departing from the true spirit and scope of the invention as defined by the appended claims.

1. A method for protecting global network web sites from cyber attacks, including the steps of:
(a) certifying a plurality of global network web sites as deserving of protection, said certifying step including the step of confirming that operators of said global network web sites each engage in primarily humanitarian activities;
(b) compiling a list of certified web sites deserving of protection;
(c) hosting a global network haven web site on a computer server, the haven web site having access to the list of certified web sites;
(d) providing a remote computer from which to conduct a cyber attack upon a targeted web site hosted at a target address;
(e) transmitting a proposed target address from the remote computer to the haven web site to determine whether the proposed target address corresponds to a certified web site;
(f) sending a signal from the haven web site to the remote computer indicating whether the web site corresponding to the proposed target address is included in the list of certified web sites; and
(g) operating the remote computer to proceed with, a cyber attack upon the proposed target address if the web site corresponding to the proposed target address is not included in the list of certified web sites, and to refrain from a cyber attack upon the proposed target address if the web site corresponding to the proposed target address is included in the list of certified web sites.

2. The method recited by claim 1 wherein:
(a) the haven web site includes an electronic file containing computer software that may be operated by a remote computer for the purpose of communicating with the haven web site to determine whether or not a web site corresponding to a proposed target address is included in the list of certified web sites; and
(b) the method includes the further step of downloading said computer software from the haven web site to a remote computer operated by one planning to conduct cyber attacks for being included in a computer virus.

3. (canceled)

4. The method recited by claim 1 wherein said step of compiling a list of certified web sites includes the step of compiling the URLs for such certified web sites.

5. The method recited by claim 1 wherein said step of compiling a list of certified web sites includes the step of compiling the IP addresses for such certified web sites.

6. A method for protecting global network web sites from cyber attacks, including the steps of:
(a) certifying a plurality of global network web sites as deserving of protection, wherein the step of certifying such global network web sites includes the step of confirming that operators of said global network web sites each engage in primarily humanitarian activities;
(b) compiling a list of certified web sites deserving of protection;
(c) hosting a global network haven web site on a computer server, the haven web site having access to the list of certified web sites;
(d) providing a remote computer from which to conduct a cyber attack upon a targeted web site hosted at a target address;
(e) establishing a link between the remote computer and the haven web site over a global computer network;
(f) downloading the list of certified web sites from the computer server to the remote computer over the global computer network;
(g) operating the remote computer to determine whether the proposed target address corresponds to a certified web site included in the downloaded list of certified web sites; and
(h) operating the remote computer to either proceed with a cyber attack upon the proposed target address if the web site corresponding to the proposed target address is not included in the downloaded list of certified web sites, and to refrain from a cyber attack upon the proposed target address if the web site corresponding to the proposed target address is included in the downloaded list of certified web sites.

7. The method recited by claim 6 wherein:
(a) the haven web site includes an electronic file containing computer software that may be operated by a remote computer for the purpose of communicating with the haven web site to download the list of certified web sites; and
(b) the method includes the further step of downloading said computer software from the haven web site to a remote computer operated by one planning to conduct cyber attacks for being included in a computer virus.

8. (canceled)

9. The method recited by claim 6 wherein said step of compiling a list of certified web sites includes the step of compiling the URLs for such certified web sites.

10. The method recited by claim 6 wherein said step of compiling a list of certified web sites includes the step of compiling the IP addresses for such certified web sites.

11. A method for protecting global network web sites from cyber attacks, including the steps of:
(a) receiving a request from an operator of a global network web site to be certified as a web site deserving of protection;
(b) evaluating the request to determine whether the web site complies with certain criteria, and certifying such web site if such criteria are met, wherein the step of evaluating the request to determine whether the web site complies with certain criteria includes the step of confirming that an operator of said global network web site engages in primarily humanitarian activities;
(c) authorizing the operator of a certified web site to add a certification marker to the certified web site to indicate that the web site is a certified web site deserving of protection;
(d) providing a remote computer from which to conduct a cyber attack upon a targeted web site hosted at a target address;
(e) establishing a link between the remote computer and the targeted web site over a global computer network;
(f) determining whether the targeted web site includes the certification marker; and
(g) operating the remote computer to either proceed with a cyber attack upon the proposed target address if the certification marker is not included in the targeted web site, or to refrain from a cyber attack upon the proposed targeted address if the certification marker is included in the targeted web site.

12. The method recited by claim 11 further including the steps of:
(a) hosting a global network haven web site on a computer server, the haven web site including an electronic file containing computer software that may be operated by a remote computer for the purpose of communicating with targeted web sites over the global computer network to discover a certification marker; and
(b) downloading said computer software from the haven web site to a remote computer operated by one planning to conduct cyber attacks for being included in a computer virus.

13. (canceled)

14. A system for protecting global network web sites from cyber attacks, comprising in combination:
(a) a computer server coupled to a global computer network and hosting a haven web site, the haven web site including a list of certified web sites deserving of protection against cyber attacks, the certified list of global network web sites consisting of global network web sites engaged in primarily humanitarian activities;
(b) at least one remote computer coupled to the global computer network, the remote computer being capable of conducting a cyber attack upon a targeted web site hosted at a target address;
(c) said at least one remote computer deriving a proposed target address against which to mount a cyber attack;
(d) said at least one remote computer transmitting the proposed target address to the haven web site to determine whether the proposed target address corresponds to a certified web site;
(e) said haven web site sending a signal to the remote computer over the global computer network indicating whether the web site corresponding to the proposed target address is included in the list of certified web sites; and
(f) said remote computer proceeding with a cyber attack upon the proposed target address if the web site corresponding to the proposed target address is not included in the list of certified web sites, and refraining from a cyber attack upon the proposed target address if the web site corresponding to the proposed target address is included in the list of certified web sites.

15. The system recited by claim 14 wherein:
(a) the haven web site includes an electronic file containing computer software that may be operated by a remote computer for the purpose of communicating with the haven web site to determine whether or not a web site corresponding to a proposed target address is included in the list of certified web sites; and
(b) said computer software is downloaded from the haven web site to a remote computer operated by one planning to conduct cyber attacks for being included in a computer virus.

16. (canceled)

17. The system recited by claim 14 wherein the certified list of global network web sites being deserving of protection includes the URLs for such certified web sites.

18. The system recited by claim 14 wherein the certified list of global network web sites being deserving of protection includes the IP addresses for such certified web sites.

19. A system for protecting global network web sites from cyber attacks, comprising in combination:
(a) a computer server coupled to a global computer network and hosting a haven web site, the haven web site including a list of certified web sites deserving of protection against cyber attacks, the certified list of global network web sites consisting of global network web sites engaged in primarily humanitarian activities;
(b) at least one remote computer coupled to the global computer network, the remote computer being capable of conducting a cyber attack upon a targeted web site hosted at a target address;
(c) said remote computer being adapted to link itself to said computer server over the global computer network to download a copy of the list of certified web sites from the haven web site;
(d) said at least one remote computer deriving a proposed target address against which to mount a cyber attack, and said remote computer being adapted to compare the proposed target address to the downloaded list of certified web sites to determine whether the proposed target address corresponds to a certified web site included in the downloaded list of certified web sites, said remote computer proceeding with a cyber attack upon the proposed target address if the web site corresponding to the proposed target address is not included in the downloaded list of certified web sites, and said remote computer refraining from a cyber attack upon the proposed target address if the web site corresponding to the proposed target address is included in the downloaded list of certified web sites.

20. The system recited by claim 19 wherein:
(a) the haven web site includes an electronic file containing computer software that may be operated by the remote computer for the purpose of communicating with the haven web site to download the list of certified web sites; and
(b) the remote computer operates the computer software downloaded from the haven web site in order to download the list of certified web sites.

21. (canceled)

22. The system recited by claim 19 wherein the certified list of global network web sites being deserving of protection includes the URLs for such certified web sites.

23. The system recited by claim 19 wherein the certified list of global network web sites being deserving of protection includes the IP addresses for such certified web sites.
